(19) United States
(12) Patent Application Publication
(10) Pub. No.: US 2014/0328982 A1
(43) Pub. Date: Nov. 6, 2014

(54) COMBINATION OF A CONTAINER FOR A LIQUID FOODSTUFF AND A QUANTITY OF PROPELLANT AND USE OF A PROPELLANT

(71) Applicant: CARDIFF GROUP, NAAMLOZE VENNOOTSCHAP, Zonhoven (BE)

(72) Inventors: Geert Norbert R. Standaert, Zonhoven (BE); Imar Vandebriel, Hechtel-Eksel (BE)

(73) Assignee: CARDIFF GROUP, NAAMLOZE VENNOOTSCHAP, Zonhoven (BE)

(21) Appl. No.: 14/362,746

(22) PCT Filed: Dec. 6, 2012
(86) PCT No.: PCT/BE2012/000052

§ 371 Date: Jun. 4, 2014

(30) Foreign Application Priority Data
Dec. 15, 2011 (BE) 2011/0722

(51) Int. Cl. B65D 83/62; A23L 2/38; C12C 12/00; B65D 83/14

(52) U.S. Cl. CPC B65D 83/62; B65D 83/752; A23L 2/38; C12C 12/00; A23V 2002/00
USPC 426/116

(57) ABSTRACT

Combination of a container (1) for a liquid foodstuff and a quantity of propellant (2) to put the container (1) under pressure in order to make the foodstuff flow out of the container (1) via an opening (11), characterised in that at a temperature of 5° C. the propellant (2) has a vapour pressure greater than 115 kPa and at a temperature of 25° C. has a vapour pressure of less than 1000 kPa.

The present invention relates to a combination of a container for a liquid foodstuff and a quantity of propellant and use of a propellant.

In containers for a liquid foodstuff, where the foodstuff must flow out, for example by opening a tap, pressure is required on the foodstuff to make it flow.

This pressure is generally provided, in beer kegs for example, by a propellant, in practice generally carbon dioxide gas (CO2) from a supply reservoir in which it is in the liquid state and/or a high pressure gaseous state, that places the container under pressure so that the beer can flow. The supply reservoir can be large or small, and connected directly or via a hose or pipe system to the container.

A problem with such a system is that at tap temperature, typically 5 to 10° C., the CO2 vapour pressure is relatively high, approx. 4000 kPa, and at room temperature approx. 7000 kPa.

This has four detrimental consequences. The first consequence is that this pressure is far too high for the beer to flow out of the container in a controlled way, the second consequence is that most containers cannot withstand such pressures, the third consequence is that it is not possible, without the availability of expensive equipment that can operate at high pressure or very low temperature, to refill a spent CO2 supply reservoir, and the fourth consequence is that this supply reservoir must be constructed to withstand the said high pressures and is thus relatively expensive.

In practice the first two disadvantages are solved by equipping the container and/or supply reservoir with an expander that reduces the pressure to a few hundred kPa, and if applicable by equipping the container with overpressure protection.

This makes the container-supply reservoir combination expensive and complex.

Moreover, there is always a part of the device that is under high pressure, and thus must withstand such a high pressure or it would run the risk of explosion.

The third disadvantage is usually solved by not reusing spent supply reservoirs, which of course is a waste of relatively expensive pressure-resistant articles, or by collecting and transporting them to a place where the necessary equipment is available. This too has many practical disadvantages and remains expensive.

Furthermore, the use of CO2 also has the disadvantage that it is a relatively small molecule, which means that the materials from which the container components are made must be specifically designed to present no or only limited CO2 permeability in the long term, in order to prevent a CO2 supply reservoir emptying over a period of weeks to months, with no pressure then available to make the foodstuff flow, as a result of CO2 diffusion, or that the foodstuff absorbs much more CO2 from the supply reservoir than is desirable for flavour reasons.

Commonly used plastics, such as polyethylene or polypropylene for example, are not suitable for keeping CO2 under pressure for a longer time without further measures such as special coatings.

As a result the choice of usable materials is limited.

The purpose of the present invention is to provide a solution to at least one of the aforementioned and other disadvantages, by providing a combination of a container for a liquid foodstuff and a quantity of propellant to put the container under pressure in order to make the foodstuff flow out of the container via an opening, whereby at a temperature of 5° C. the propellant has a vapour pressure greater than 115 kPa and at a temperature of 25° C. has a vapour pressure of less than 1000 kPa.

The term propellant is used here, as is usual in this field, for a product or mixture of products that are partly gaseous and partly liquid or solid, whereby the fraction that is gaseous depends on the volume of the space in which the product is located, the quantity of product present in this volume, and the temperature of the system. Not only the gaseous part, but also the liquid part or solid part of the product is called propellant.

Such a combination has the advantage that a space or reservoir provided for such a propellant can be filled with relatively simple means, that can only handle a pressure of 1000 kPa, while providing sufficient pressure to make this foodstuff flow out of the container, also at the ideal consumption temperature of the foodstuff.

The combination can also be constructed in materials that are not necessarily able to withstand a high pressure and are thus cheaper.

A reduction valve is not necessary either, so that this relatively expensive component can be avoided. Nevertheless if a reduction valve is used, it can be constructed much more simply on account of the much lower pressures.

Preferably the vapour pressure at 5° C. is at least 150 kPa, and/or the vapour pressure at 25° C. is a maximum of 700 kPa.

Preferably the propellant contains at least two atoms of carbon per molecule.

This has the advantage that because such propellants have relatively large molecules, and thus cannot significantly diffuse through most standard plastics, the container can be constructed from cheap materials.

Preferably the propellant consists of 1,1,1,2,3,3,3 heptafluoropropane, HFC-227, or 1,1,1,2 tetrafluoroethane, HFC 134a or contains this.

In a preferred embodiment the container comprises a rigid outer container and a flexible inner container, whereby the container is designed to be placed under pressure by means of the presence of at least a part of the quantity of propellant in the space between the inner container and outer container.

This is a practical way to construct a container for a liquid foodstuff, whereby the liquid foodstuff is in the flexible inner container when the container is filled with liquid foodstuff.

In a preferred embodiment the vapour pressure of the propellant at all temperatures between 1° C. and 30° C. is greater than the vapour pressure of the components of the liquid foodstuff at the same temperature.

An advantage of this is that an undesirable situation is avoided, i.e. one that arises due to components of the liquid foodstuff, in particular CO2 in soft drinks and beer, being able to escape from the drink at a pressure below their equilibrium pressure.

Although in this case there is sufficient pressure to make the drink flow out of the container, this is nonetheless an undesirable situation because the CO2 is extracted from the drink, and the drink thus contains less CO2 than expected, such that flavour changes can occur.

In such a case, the part of the container in which the drink is located will be filled with the escaped gas and/or with foam, such that gas or foam instead of the drink can flow out of the opening, certainly when the container is not kept completely straight.

By selecting the propellant such that it satisfies the above preferred characteristic, this is prevented.

In a further preferred embodiment the container is designed to completely contain the quantity of propellant within itself.

In order to be able to fulfil its role, the container must of course also be able to contain within itself the quantity of foodstuff for which it is designed.

This has the advantage that a ready-to-use container in which the propellant is already present can be delivered to an end consumer ready for use, whereby a separate capsule of propellant is not needed.

Preferably the container comprises a closing part with a stop valve, whereby the closing part, when the stop valve is open, contains the opening and whereby the closing part contains a space for the liquid part of the quantity of propellant.

The closing part is not necessarily equipped with a tap to also operate the stop valve, and is to be considered as separate from this. Such a tap can be affixed just before use so that this protruding, and thus susceptible to damage, component cannot be damaged during transport of the container.

The space for the liquid part of the propellant can be closed off from the rest of the container via a removable block, whereby the container is activated by removing or piercing the block, as a result of which the propellant can exert pressure on the foodstuff.

The invention also relates to the use of a propellant, which at a temperature of 5° C. has a vapour pressure greater than 115 kPa and at a temperature of 25° C. has a vapour pressure of less than 1000 kPa, to place a liquid foodstuff under pressure in a container that is intended to let the liquid foodstuff flow out in a controlled way.

With the intention of better showing the characteristics of the invention, a few preferred embodiments of a combination and use according to the invention are described hereinafter by way of an example, without any limiting nature, with reference to the accompanying drawings, wherein:

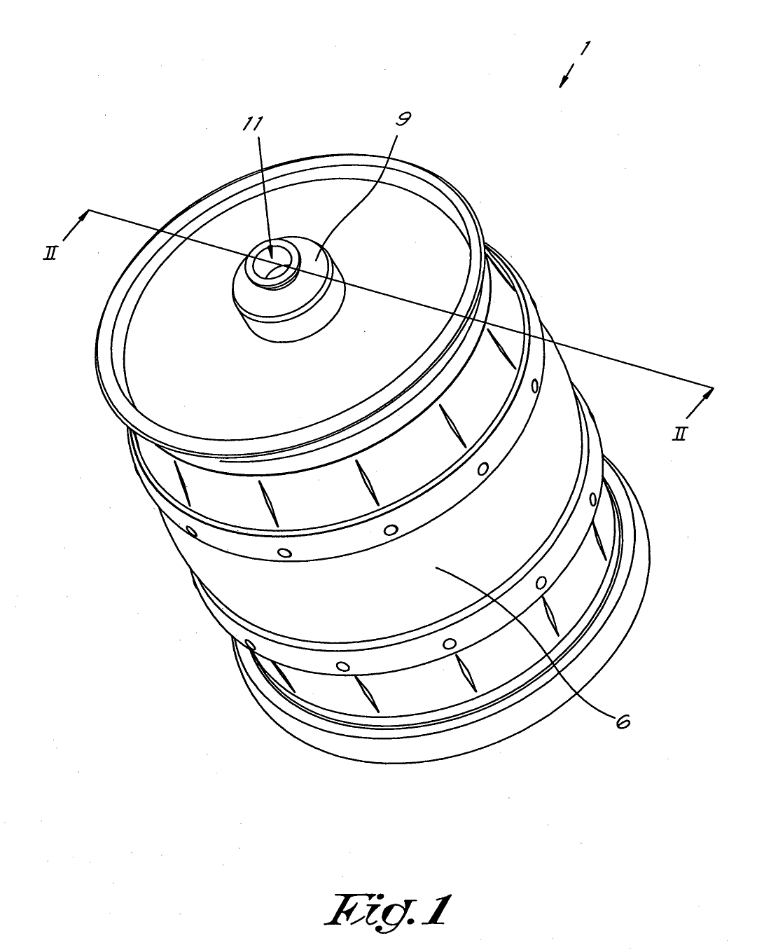

FIG. 1 schematically shows a perspective view of a combination according to the invention;

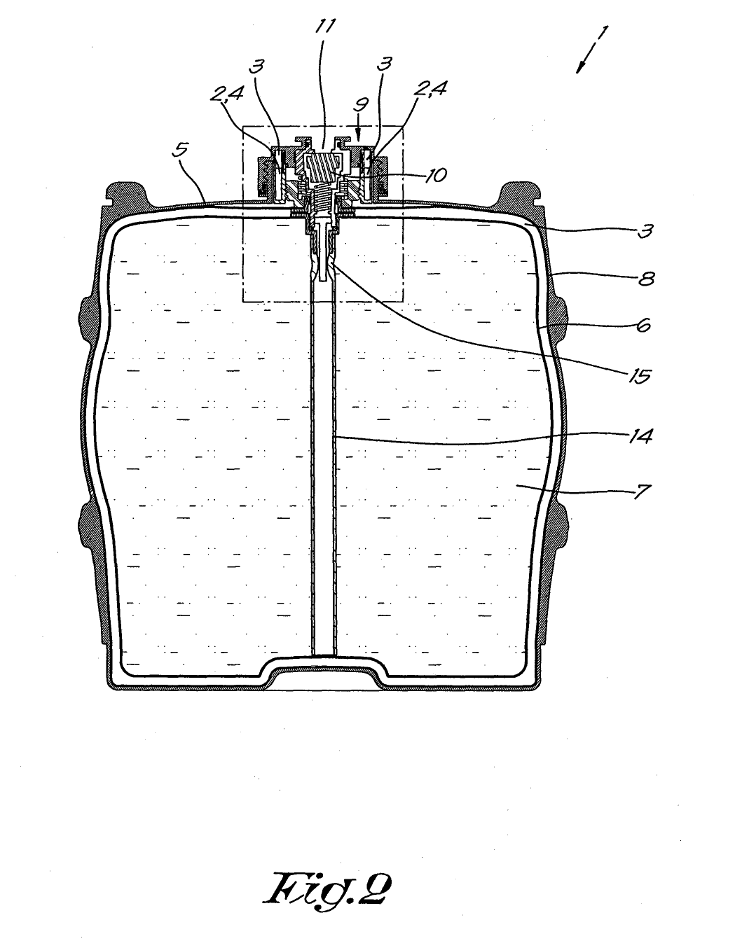

FIG. 2 shows a cross-section of the combination of FIG. 1;

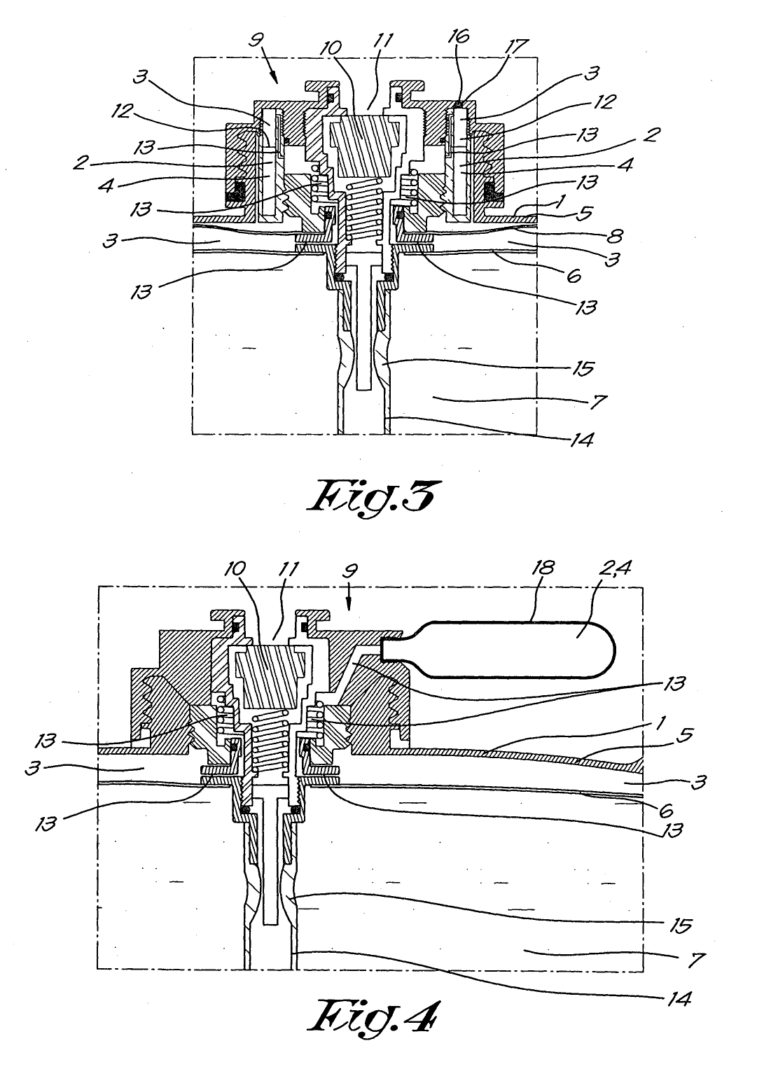

FIG. 3 shows the part designated in FIG. 2 by F3 on a larger scale; and

FIG. 4 shows a cross-section of an alternative embodiment of a combination according to the invention.

The combination shown in FIGS. 1, 2 and 3 consists of a container 1 for a liquid foodstuff, in this case a beer keg, and a quantity of propellant 2. This propellant is partly in a gaseous state, thus a gaseous part 3, and partly in a liquid state, thus a liquid part 4. In this example the propellant 2 is 1,1,1,2,3,3,3 heptafluoropropane or HFC-227.

At 5° C. this propellant has a vapour pressure of 235 kPa, and at 25° C. a vapour pressure of 458 kPa. If the pressure in the space in which the propellant 2 is located is less than the said pressure, the liquid part 4 of the propellant will partially evaporate into a gaseous propellant 2, until the pressure is the said pressure. If the pressure in the space in which the propellant is located is greater than the said pressure, the gaseous part 3 of the propellant 2 will condense into liquid propellant 2.

The container 1 has a non-flexible outer wall or outer container 5, for example made of polyethylene, a flexible inner container 6 made of film and intended to contain beer 7, and a flexible intermediate container 8, also made of film.

The inner container 6 and intermediate container 8 are secured to a closing part 9 that is equipped for mounting a tap on it.

The closing part 9 also comprises a stop valve 10 that can be activated by a tap to be mounted, and which can open and close an opening 11 to allow the beer 7 to flow out.

The closing part 9 also comprises an internal space 12 that acts as a storage space for the liquid part 4 of the propellant 2. This space 12 has an open connection via channels 13 to the space between the inner container 6 and the intermediate container 8.

The closing part 10 is connected to a riser pipe 14, in which a flow resistance 15 is affixed.

This flow resistance 15 essentially consists of a flexible part of silicone rubber.

The internal space 12 is provided with an opening to the outside with a conical rubber seal 16, which is placed in a conical recess 17.

The operation of the combination is simple and as follows.

The inner container 6 is filled with beer 7 by opening the stop valve 10, applying a vacuum via the opening 11 such that the inner container 6 is sucked completely empty, and then by introducing the desired quantity of beer 7 into the inner container 6 via the opening 11.

The space 12 is then filled with propellant 2 in its liquid state. This is done by inserting a hollow needle through the seal 16 and introducing the desired quantity of propellant 2 into the space 12 via this hollow needle under a pressure at which the propellant 2 is liquid, thus a pressure of 500 kPa at 25° C. for example.

The needle is then withdrawn, whereby as a result of the pressure exerted by the propellant on the seal. 16, this seal 16 is pushed in the recess 17, such that the opening formed by the needle is again pushed shut so that the propellant 2 cannot escape.

The liquid part 4 of the propellant 2 will now partly evaporate into a gaseous propellant 2, until the pressure in the space 12 and the connected space between the inner container 6 and intermediate container 8, is equal to the vapour pressure of the propellant 2.

The propellant 2 is selected such that at all temperatures at which the container 1 is intended to operate, it has a higher vapour pressure than the volatile components dissolved in the beer.

As a result the container 1 is placed under pressure and is ready for use, which is the situation as shown in FIGS. 1 and 2 and 3.

When the stop valve 10 is now activated by the tap (not shown), beer 7 flows from the container 1, more specifically from the flexible inner container 6 through the opening 11 to the outside, as a result of the pressure exerted on the inner container 6 by the propellant 2.

The beer 10 hereby passes the flow resistance 15 in the riser pipe 14.

This flow resistance 15 depends on the pressure difference between the container 1 and atmospheric pressure, whereby the resistance that the flowing beer experiences is greater at a greater pressure difference. This pressure difference is not constant because the container 1 can be used at different temperatures, whereby the pressure in the container 1 is higher at a higher temperature.

The flow resistance 15 is designed such that as a result of this pressure difference the flexible part in the riser pipe 14 deforms to a greater extent at a higher pressure difference, and pushes the riser pipe 14 closed to a greater extent. As a result, the outflow rate is more or less independent of the pressure difference.

Because the beer 7 flows out of the container 1, the volume of the space between the inner container 6 and the intermediate container 8 becomes larger, such that the pressure in this space falls. As a result of this some of the liquid part 4 of the propellant 2 will evaporate, so as to make the pressure in this space equal to the vapour pressure of the propellant 2.

The alternative embodiment shown in FIG. 4 essentially differs from the embodiment described above in two aspects.

The first difference is that there is no internal space 12 for a liquid part 4 of the propellant 2. Instead of this there is a separate reservoir 18 for propellant 2, and also a connection for this reservoir 18.

Before this reservoir 18 is connected to the container 1, all propellant 2 is in the reservoir 18. After connection a part the propellant 2 will flow to the container.

The second difference is that there is no intermediate container 8. The reservoir 18 is connected to the space between the outer container 5 and the inner container 6, where the gaseous part 3 of the propellant 2 is primarily located.

It is also possible that absolutely no space 12 or reservoir 18 is provided for propellant 2, but the propellant is brought directly into the space outside the inner container 6 but inside the outer container 5, and from there exerts pressure directly on the inner container 6. Of course the closing part 9 or the outer container 5 must be provided with a possibility for introducing the propellant 2.

As an alternative to the flow resistance 15, a flow control can be fitted on the tap in order to be able to tap off, both when the container has a relatively low temperature and thus low pressure, and when the container has a higher temperature and thus higher pressure.

In the above example the combination is shown such that the quantity of propellant 2 is already connected to the container 1. It is however also possible to consider the combination as a container for a drink and a quantity of propellant that are not connected together, but which are designed to be connected and to work together.

The present invention is by no means limited to the embodiments of a combination and use according to the invention described as an example and shown in the drawings, but such a combination and use can be realised in all kinds of variants, without departing from the scope of the invention.

1. Combination of a container (1) for a liquid foodstuff and a quantity of propellant (2) to put the container (1) under pressure in order to make the foodstuff flow out of the container (1) via an opening (11), characterised in that at a temperature of 5° C. the propellant (2) has a vapour pressure greater than 115 kPa and at a temperature of 25° C. has a vapour pressure of less than 1000 kPa.

2. Combination according to claim 1, characterised in that the foodstuff is a drink.

3. Combination according to claim 2, characterised in that the drink is beer.

4. Combination according to claim 1, characterised in that the foodstuff is a sauce.

5. Combination according to claim 1, characterised in that the propellant (2) consists of 1,1,1,2,3,3,3 heptafluoropropane or HFC-227, or 1,1,1,2 tetrafuoroethane or HFC 134a, or contains this.

6. Combination according to claim 1, characterised in that the container (1) comprises a rigid outer container (5) and a flexible inner container (6), whereby the container (1) is configured to be placed under pressure through at least a part of the quantity of propellant (2) being within the outer container (5).

7. Combination according to claim 6, characterised in that the container additionally comprises a flexible intermediate container located between the inner container and the outer container, whereby the container is designed to be put under pressure by means of the presence of at least a part of the quantity of propellant in the space between the inner container and the intermediate container.

8. Combination according to claim 6, characterised in that at least a part of the quantity of propellant (2) is in the space between the inner container (6) and the outer container (5).

9. Combination according to claim 1, characterised in that the quantity of propellant (2) is at least partly in a liquid state (4) in a reservoir (18), and the container (1) and/or the reservoir (18) is or are equipped with connection means through which the reservoir (18) can be connected to the container (1) to put it under pressure.

10. Combination according to claim 1, characterised in that the container (1) is designed to completely contain the quantity of propellant (2) within itself.

11. Combination according to claim 10, characterised in that the container (1) comprises a closing part (9) with a stop valve (10), whereby the closing part (9), when the stop valve (10) is open, comprises the opening (11), and whereby the closing part (9) comprises a space (12) for the liquid part (4) of the quantity of propellant (2).

12. Combination according to claim 1, characterised in that the container (1) comprises a flow resistance (15) for the drink flowing out of the container (1) whereby the flow resistance (15) depends on the pressure in the container (1).

13. Combination according to claim 1, characterised in that the container (1) is equipped with a reduction valve that prevents the flow of the propellant (2) if the pressure in the space between the inner container (6) and the outer container (5) is greater than the vapour pressure of the propellant (2) less a certain value.

14. Combination according to claim 1, characterised in that the vapour pressure of the propellant (2) at all temperatures between 1° C. and 30° C. is greater than the vapour pressure of the components of the drink at the same temperature.

15-20. (canceled)
